(19) United States
(12) Patent Application Publication
(10) Pub. No.: US 2009/0157903 A1
(43) Pub. Date: Jun. 18, 2009

(54) Methods and Apparatus for Trouble Reporting Management in a Multiple System Service Environment

(76) Inventors: Stanford Lewis, Irvington, NJ (US); Mojgan Dardashti, Holmdel, NJ (US); Sridar Seetharaman, Edison, NJ (US)

Correspondence Address: AT & T LEGAL DEPARTMENT - PG, ATTN: PATENT DOCKETING , ROOM 2A- 207, ONE AT &T WAY, BEDMINSTER, NJ, 07921, US

(21) Appl. No.: 11/958,851

(22) Filed: Dec. 18, 2007

(51) Int. Cl. G06F 15/16

(52) U.S. Cl. 709/246

(57) ABSTRACT

Systems and techniques for managing and acting on trouble reports. A system comprising a plurality of subsystems maintains a central exchange for mediating problem referrals and resolutions between subsystems. A subsystem receives a trouble report and creates a trouble ticket in its native format. To refer the trouble ticket or a problem, the referral information, is translated to a generic format of the exchange. Appropriate problems are referred to subsystems, translating problem information into the native format of a receiving subsystem. Information generated by a receiving subsystem in its native format, including cause and root cause information for the problem, is translated to the generic format of the central exchange, and used to update the trouble ticket. After the central exchange has finished with the trouble ticket, the ticket is translated to the native format of its originating subsystem and further steps are taken by the originating subsystem as appropriate.

### FIELD OF THE INVENTION

The present invention relates generally to improvements for management of trouble reporting and correction for service assurance. More particularly, the invention relates to centralized management and translation of trouble codes and descriptions and trouble cause codes and descriptions in a multi-system environment.

### BACKGROUND OF THE INVENTION

Modern large systems providing services to customers, such as large communication systems, typically maintain some mechanism for receiving and managing trouble reports from customers. A customer reports a problem and a description of the problem is entered, frequently in a form commonly known as a trouble ticket. The trouble ticket includes information such as a trouble code and trouble description, and is routed to various stations for response. Responses to the ticket's arrival at a station can include diagnostic steps, steps taken to solve the problem, report to the customer or other entities, or any alternative or additional appropriate steps. As each step is taken, the trouble ticket is suitably updated with additional information, such as an action description suitably accompanied by an action code, a results description suitably accompanied by a results code, a trouble root cause and sub root cause description suitably accompanied by a root cause and sub root cause code, or other additional information.

Modern large systems may include a large number of different elements. A communication system, for example, may include a wireless telephone network, a landline telephone network, a wireless data system, an internet service provider, and any other number of different elements. Each of these systems may include trouble reporting facilities, and may include different reporting systems for different facilities. In addition, many large systems grow in a piecewise fashion as providers merge or acquire other providers, so that one provider may include, for example, two wireless telephone networks, created or acquired at different times under different management, each with its own trouble reporting system, using different trouble descriptions and codes. In many cases, trouble tickets originating in one portion of a large system maybe routed to different portions of the system using different trouble codes and descriptions, in order to best use the available services.

### SUMMARY OF THE INVENTION

Among its several aspects, the present invention recognizes that routing trouble tickets from one part of a system, conveniently referred to here as a subsystem, to another subsystem, with each system normally using different trouble codes from another, may lead to confusion and inefficiency that reduces or eliminates the advantages that were to be obtained by routing to whichever destination is best able to provide the needed services. Therefore, a system according to the present invention implements a suitable trouble report management and translation repository, maintaining a centralized trouble coding system, including trouble codes and descriptions for each possible problem. Any trouble ticket that is to be referred to another subsystem maintaining a different descriptive system for trouble reporting is passed through the centralized repository. Each of the various subsystems includes facilities for translating between its native trouble codes and descriptions and the generic codes and descriptions. Alternatively, such translation may be accomplished by the central repository for some or all subsystems. A subsystem is therefore able to generate a trouble ticket using its own codes and terminology, and can then route or refer the trouble ticket to another subsystem, with the codes and terminology being translated to those used by the receiving subsystem. The receiving subsystem is then able to address the reported problem and update the trouble ticket using its own codes and terminology, and to route the trouble ticket back to the referring subsystem, or a different subsystem which may address the issuer further, with each subsystem being able to address the trouble ticket using its own native codes and terminology.

A more complete understanding of the present invention, as well as further features and advantages of the invention, will be apparent from the following Detailed Description and the accompanying drawings.

### BRIEF DESCRIPTION OF THE DRAWINGS

FIG. 1 illustrates an exemplary communication system employing trouble reporting and management and response techniques according to an aspect of the present invention;

FIG. 2 illustrates details of a trouble reporting system according to an aspect of the present invention; and

FIGS. 3A and 3B illustrate a process of trouble reporting and trouble response according to an aspect of the present invention.

### DETAILED DESCRIPTION

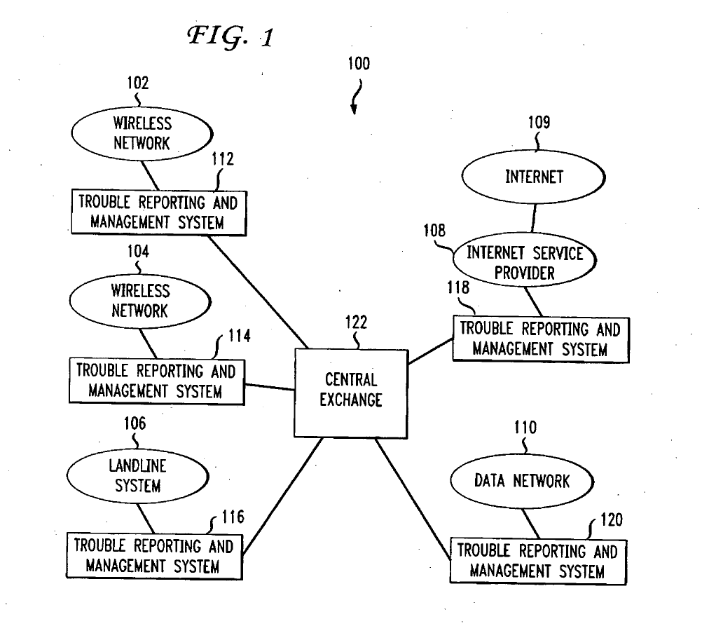

FIG. 1 illustrates a communication system 100 according to an aspect of the present invention. The system includes a plurality of subsystems, including first and second wireless telephone networks 102 and 104, landline telephone system 106, internet service provider 108 providing a connection to the Internet 109, and wireless data network 110. The subsystems 102, 104, 106, 108, and 110 include trouble reporting and management systems 112, 114, 116, 118, and 120, respectively. Each trouble reporting system 112 may suitably include a server with facilities for receiving information from customers, for example, automatically from customer devices or through automated or employee mediated interactions with customers. Exemplary trouble reporting systems are described in greater detail below.

When one of the trouble reporting and management systems 112-120 receives a trouble report, it creates a trouble ticket with information describing the nature of the problem. The trouble ticket is suitably created as a computer record for transmission and routing over data processing systems and computer networks, including storage in a computer database. This information suitably includes a trouble code, indexing the problem to a repository of information, such as a database, which may include information about the problem, possible causes of the problem, and steps to be taken in resolution of the problem. Each reporting system may use codes and terminology native to the subsystem with which it is used. Each of the reporting systems 112-120 orders problem resolution steps as needed, and the problem resolution steps may include referring the problem to appropriate parties or systems for operations. The trouble ticket is updated as actions are taken, and referred appropriately until the problem is resolved.

At times, a trouble ticket originating in one subsystem may be referred to another subsystem for action. When this occurs, the trouble ticket is passed to a central exchange 122, which maintains its own generic codes and terminology that map to the codes and terminology used by each subsystem. In the present exemplary embodiment, each of the subsystems will be seen as providing translation of its own codes and terminology to the generic codes and terminology used by the central exchange 122, but it will be recognized that the central exchange 122 may provide translation services itself. The central exchange 122 may provide diagnostic and problem resolution services of its own, and may also refer the problem to another of the subsystems 102-110 for action. When the central exchange 122 refers a problem to a subsystem, the central exchange 122 may suitably use its own generic codes for the referral. The subsystem receiving the referral translates the generic code into its own native code and makes the appropriate diagnoses and takes the appropriate actions. When a trouble ticket is to be closed, the originating subsystem is given cause and root cause information. The central exchange 122 therefore maintains generic cause and root cause codes and descriptions, and a subsystem to which a trouble report was referred provides cause and root cause information in the generic language used by the central exchange 122. The central exchange 122 then provides this information to the originating subsystem, which then translates the generic information to its own native codes and terminology in order to close the trouble ticket.

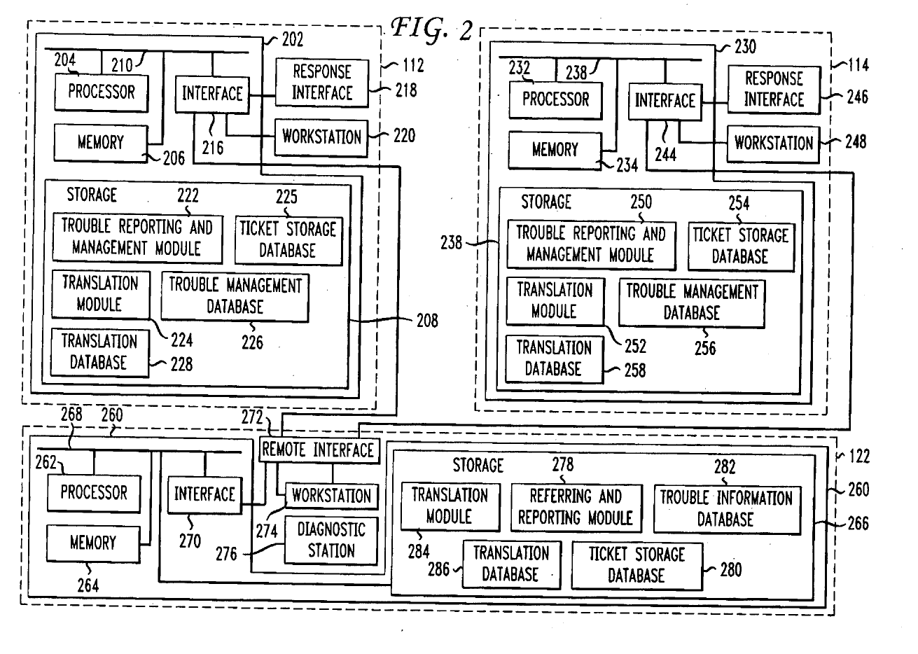

FIG. 2 illustrates additional details of the trouble reporting system 112 belonging to the subsystem 102, the central exchange 122, and the trouble reporting system 114 belonging to the subsystem 104. The trouble reporting systems 116, 118, and 120 are not described in detail here in order to avoid repetitive description, but may suitably be configured, and operate, in a similar way to the systems 112 and 114.

The trouble reporting system 112 suitably includes a server 202, including a processor 204, memory 206, and long term storage 208, all suitably communicating with one another over a bus 210. The server 202 also includes an external communication interface 216, responsive to trouble reports received from a customer response interface 218 and a remote employee workstation 220. The server 202 maintains a trouble reporting module 222, a translation module 224, a ticket storage database 225, and a trouble management database 226 including native trouble codes, description, cause and root cause codes and information, and procedures to be followed in resolving trouble reports. The server 202 also suitably maintains a translation database 228, providing mapping between native and generic codes and terminologies for each trouble code, trouble description, cause and root cause description and code, and other desired elements of trouble ticket information. When a trouble ticket is to be referred to the central exchange 122, the translation module 224 performs appropriate translation, presenting the trouble ticket to the central exchange 122 in the generic format used by the central exchange 122. The trouble ticket as created by the trouble reporting system 112 may suitably be in the form of a database record or other suitable computer record, with codes and descriptions or instructions for various data and activities, such as a description of a problems in terms of symptoms, possible affected systems, possible causes, and other information, as well as any instructions that may be included, such as routing information for the trouble ticket or activities to be performed in diagnosis and correction of the problem., and the translation module 224 suitably converts such information from the native format of the trouble reporting system 112 to the generic format of the central exchange 122.

The trouble reporting system 114 may include similar components to the system 112. In the example presented here, the trouble reporting system 114 comprises a server 230, including a processor 232, memory 234, and long term storage 236, all suitably communicating with one another over a bus 238. The server 230 also includes an external communication interface 244, responsive to trouble reports received from a customer response interface 246 and an employee workstation 248. The server 230 maintains a trouble reporting module 250, a translation module 252, a ticket storage database 254, and a trouble management database 256, as well as a translation database 258.

The central exchange 122 similarly includes a server 260, including a processor 262, memory 264, and long term storage 266, communicating over a bus 268. The server 260 also includes an external interface 270, responsive to a remote interface 272 communicating with the trouble reporting system 112 and 114. The server 260 also communicates through the remote interface with a plurality of trouble referral stations, such as an employee workstation 274 and a diagnostic station 276, used by the central exchange 122 to provide support services. The server 260 refers trouble report information to its own stations such as the station 274 and 276 in its own generic format, and these stations employ the generic format when addressing the issues referred by the server 260.

The server 260 communicates with the systems 112 and 114 to receive reports, or trouble tickets, referred to the exchange 122 by one of the subsystems 102 and 104, to refer to trouble indications to subsystems other than the reporting subsystem, and to return information to the reporting subsystem. For example, the reporting system 112 may refer a trouble ticket to the exchange 122, and the exchange 122 may then make a referral to the subsystem 104, so that a report code is passed to the system 114. To manage referrals of trouble tickets and trouble reports, the server 260 hosts a referring and reporting module 278, which provides routing and referral for trouble tickets and trouble reports, a ticket storage database 280, and a trouble information database 282, suitably including code and description information, and cause and root cause codes and information, in the generic format used by the central exchange 122.

Suppose that a user of the system 102 reports a problem. The reporting system 112 gathers information about the problem and creates a trouble ticket, using native codes and descriptive information in a standard format used to provide for uniformity and to maximize the ability to automate responses. In the present example, the user is experiencing slow data transmission for a data capable wireless telephone. The trouble report format may read as follows:

| CODE | DESCRIPTION |
|---|---|
| 04A | SLOW WIRELESS DATA TRANSMISSION |

The reporting module 222 prepares an appropriate trouble ticket and routes the ticket for action. In the present exemplary case, the reporting module 222 determines that the ticket is to be routed to the central exchange 122, so that the various data services shared by the various subsystems served by the exchange 122 may be examined for proper operation and for connectivity to the subsystem 102.

In order to pass the trouble ticket to the exchange 122, the system 112 employs the translation module 224, which employs the translation database 228 to translate the trouble ticket into the generic format used by the exchange 122. The translation database 228 suitably includes a comprehensive list of trouble codes and descriptions, as well as any other information used in the trouble ticket in the native format of the subsystem 102. The translation database 228 maps each element of information to a corresponding element in the generic format of the exchange 122. Because the exchange 122 provides services to all subsystems of the system 100, each information element used by each subsystem will suitably have a corresponding generic element supported by the exchange 122. This correspondence can be maintained even if a particular information element is not used in tickets routed beyond the subsystem with which it is used, because the trouble reporting techniques described herein are intended to support expansion, so that if a future need or desire arises to route a trouble code or description, that need can be met with a minimum of modification.

In the present exemplary embodiment, the translation database 228 suitably includes, for the elements under consideration, the following mapping:

| NATIVE | | GENERIC | |
|---|---|---|---|
| CODE | DESCRIPTION | CODE | DESCRIPTION |
| 04A | SLOW WIRELESS DATA | 35 | SLOW WIRELESS |
| | TRANSMISSION | | DATA |
| | | | TRANSMISSION |

A trouble ticket is therefore prepared by the trouble reporting module 222 for routing to the central exchange 122, with information in the generic format used by the central exchange 122. The referring and reporting module 278 manages the trouble ticket, providing services and updating the trouble ticket with the results of those services, and referring actions to other subsystems as required.

In the present example, the referring and reporting module 278 passes the trouble code and description to the subsystem 104. The entire trouble ticket need not necessarily be passed to the subsystem 104, instead, the referring and reporting module 278 may manage the trouble ticket until it is returned to the reporting subsystem, in this case the subsystem 102. The trouble reporting system 114 receives the referral, which is processed by the trouble reporting and management module 250. The trouble reporting and management module 250 passes the referral to the translation module 252. The translation module 252 consults the translation database 256, which includes mapping information similar to that of the database 228, except that the translation database 256 includes information for mapping between generic codes and descriptions and the native codes and descriptions used by the subsystem 104.

In the present example, the translation database 256 suitably includes, for the elements under consideration, the following mapping:

| NATIVE | | GENERIC | |
|---|---|---|---|
| CODE | DESCRIPTION | CODE | DESCRIPTION |
| 016C | SLOW WIRELESS DATA | 35 | SLOW WIRELESS |
| | TRANSMISSION | | DATA |
| | | | TRANSMISSION |

The reporting and management module 250 proceeds to address the problem, performing testing, diagnosis, and repair as needed. The referral may have been performed, for example, because the subsystem 104 includes data components used by the subsystem 102, so that the poor quality of service experienced by the user of the subsystem 102 may have occurred because of a problem with the subsystem 104.

In the present example, the reporting and management module 250 determines that the problem was caused by Internet access problems affecting the subsystem 104, and that these problems were in turn caused by a routing address error. These errors are associated with root cause and sub root cause codes, which are associated with the trouble ticket in order to provide logging and accounting for actions taken and their results. The reporting and management module 250 reports the results of the referral to the central exchange 122. In order to perform the report, the reporting and management module 250 invokes the translation module 252, which translates the native root cause and sub root cause codes to the generic format used by the central exchange 122. The translation database 256 includes the following mapping:

| NATIVE | | GENERIC | |
|---|---|---|---|
| ROOT CAUSE | | ROOT CAUSE | |
| CODE | DESCRIPTION | CODE | DESCRIPTION |
| 097A | INTERNET | 128 | INTERNET |
| | ACCESS FAILURE | | ACCESS |
| | | | FAILURE |

| SUB ROOT | | SUB ROOT | |
|---|---|---|---|
| CAUSE | | CAUSE | |
| CODE | DESCRIPTION | CODE | DESCRIPTION |
| 375 | ROUTING | 925 | ROUTING ADDRESS |
| | ADDRESS | | FAILURE |
| | FAILURE | | |

The root cause and sub root cause information is transferred to the central exchange 122 in the generic format used by the central exchange 122. The referring and reporting module 278 adds the information to the trouble ticket and passes the trouble ticket back to the subsystem 104 for further action. This operation may result in closure of the trouble ticket by the subsystem 104 if all problems have been resolved, or further action or routing if problems remain. When the reporting system 114 receives the trouble ticket, it translates the generic format information in the trouble ticket to the native format of the subsystem 104. If desired, only the information that was changed needs to be translated, so that the original information describing the problem, and other information known to be unchanged, can simply be copied from the trouble ticket in the state it was in before referral to the central exchange 122. The reporting module 222 suitably invokes the translation module 224, which in turn consults the translation database 228, to translate the root cause and sub root cause information to the native format of the subsystem 104. In the present example, the relevant mapping information stored in the translation database 228 is as follows.

| NATIVE | | GENERIC | |
|---|---|---|---|
| ROOT CAUSE | | ROOT CAUSE | |
| CODE | DESCRIPTION | CODE | DESCRIPTION |
| 230D | INTERNET | 128 | INTERNET |
| | ACCESS FAILURE | | ACCESS |
| | | | FAILURE |

| SUB ROOT | | SUB ROOT | |
|---|---|---|---|
| CAUSE | | CAUSE | |
| CODE | DESCRIPTION | CODE | DESCRIPTION |
| 420A | ROUTING | 925 | ROUTING ADDRESS |
| | ADDRESS | | FAILURE |
| | FAILURE | | |

Once the trouble ticket has been updated, appropriate further action is taken, such as closure, or subsequent action or routing by the system 112.

For simplicity, an exemplary routing by one subsystem 102 to the central exchange 122, and referral by the central exchange 122 to only one subsystem 104 has been described above, but it will be recognized that the central exchange 122 may receive trouble tickets from multiple subsystems and may refer problems from one trouble ticket to multiple subsystems if needed, with responsive reporting to multiple subsystems as well.

Further, while the reporting systems 112 and 114 are illustrated here as implementing translation facilities, it will be recognized that a system according to the present invention can easily be designed so that one, some, or all of the reporting systems maintained by a subsystem do not need to implement translation capability, but can simply transfer information to the central exchange 122 for translation by facilities maintained within the central exchange 122. Therefore, the central exchange 122 is shown here as implementing a translation module 284 and a translation database 286. The translation module 284 and translation database 286 may be optional, and the translation database 286 may include translation information for subsystems whose reporting systems do not maintain their own translation capabilities or, if desired, may include translation information for every subsystem.

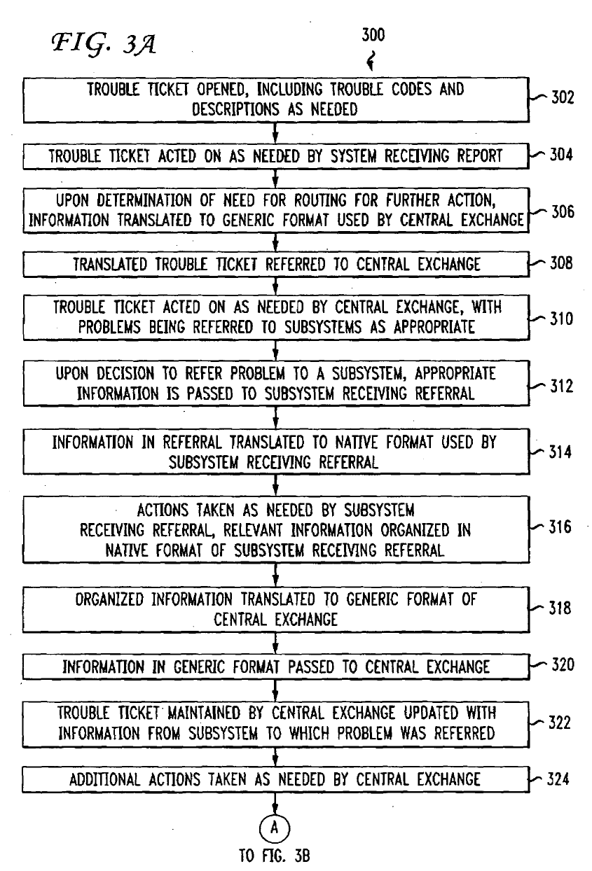

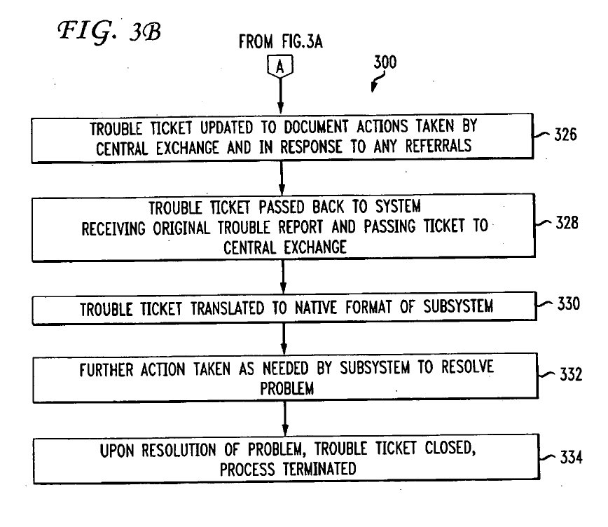

FIG. 3 illustrates a process 300 of problem resolution according to an aspect of the present invention. At step 302, upon reporting of a problem to a service assurance facility by a customer served by a system on whose behalf the facility is maintained, a trouble ticket is opened, with trouble codes and descriptions entered into the ticket as needed. The trouble ticket may suitably take the form of a database record or other computer record, and may include standardized codes and descriptions used by the system. At step 304, the trouble ticket is acted on as needed by the system receiving the trouble report. This system may be part of a larger system, and will be referred to hereinafter as a subsystem. At step 306, upon determination of a need to route the trouble ticket to a central exchange for further action, including possible referral to other subsystems, information stored in the trouble ticket in a native format of the reporting subsystem is translated to a generic format used by the central exchange. At step 308, the translated trouble ticket is referred to the central exchange, for example, by transmitting the translated ticket to the exchange in the form of a computer record transmitted over a packet switched network or other transmission medium. At step 310, the central exchange addresses the trouble ticket as needed, taking action on its own as appropriate and referring problems to other subsystems when referral is needed, identifying instructions, descriptions, and other information by examining codes and descriptions and comparing the codes and comparing the information to its own databases and stored records.

At step 312, upon referral of a problem to a subsystem other than the reporting subsystem, relevant information, such as a code and description in the generic format of the central exchange, is passed to the subsystem receiving the referral. At step 314, the information passed to the subsystem in the referral is translated to the native format of the subsystem receiving the referral. At step 316, actions are taken as needed by the subsystem receiving the referral, and any information gathered is organized in a standardized format used by the subsystem receiving the referral. This information may include root cause and sub root cause codes identifying the problems and solutions found. At step 318, the organized information is translated into the generic format used by the central exchange. At step 320, the information in generic format is passed to the central exchange, suitably in the form of a computer record transmitted over a packet switched network or other transmission medium.

At step 322, the trouble ticket maintained by the central exchange is updated with the information received from the subsystem to which the problem was referred. At step 324, the central exchange takes any additional actions needed, such as taking further actions or making further referrals. Referrals may include translation of codes and descriptions by a subsystem to which a problem is referred, with information translated to the generic format and passed to the central exchange. At step 326, the trouble ticket is updated with any additional information generated to document the actions taken by the central exchange and any referrals made by the central exchange and the results of those referrals. At step 328, the trouble ticket is passed back to the subsystem receiving the problem report and passing the trouble ticket to the central exchange. At step 330, the trouble ticket is translated from the generic format of the central exchange to the native format of the subsystem. At step 332, the subsystem takes any additional further action needed to resolve the problem. At step 334, upon resolution of the problem, the trouble ticket is closed and the process terminates.

While the present invention is disclosed in the context of a presently preferred embodiment, it will be recognized that a wide variety of implementations may be employed by persons of ordinary skill in the art consistent with the above discussion and the claims which follow below.

We claim:

1. A trouble management facility for responding to indications of trouble affecting a user of a communication system, the trouble management facility including:
an interface for receiving indications of trouble affecting a user;
a data processing facility for responding to indications of trouble received over the interface;
a trouble report and management module hosted in the data storage facility, for examining an indication of trouble and creating a trouble ticket in a native format of a communication subsystem with which the trouble management facility is used, the trouble ticket including stored data providing information relating to the nature of the trouble that for which an indication has been received; and
a translation module for translating the trouble ticket to a generic format of a central exchange mediating between the trouble management facility and a second trouble management facility to which a problem indicated in the trouble ticket may be referred.

2. The trouble management facility of claim 1, wherein the trouble ticket is a standardized record including information for examination and routing by automated data processing facilities.

3. The trouble management facility of claim 2, further comprising an interface for receiving information from the central exchange, the information including information generated by the second trouble management facility in response to a referral of a trouble report, the information including root cause and sub root cause information passed to the trouble management facility in a generic format by the central exchange, the translation module being operative to translate the information received from the central exchange to the native format of the trouble management facility.

4. The trouble management facility of claim 3, wherein the data providing information relating to the nature of the trouble includes a standardized trouble code and wherein the translation module translates a trouble code in the native format of the subsystem to a trouble code in the generic format used by the central exchange.

5. The trouble management facility of claim 3, wherein the root cause and sub root cause information includes root cause and sub root cause codes and wherein the translation module translates root cause and sub root cause codes in the generic format of the central exchange to root cause and sub root cause codes in the native format of the subsystem.

6. The trouble management facility of claim 1, wherein the information generated by the second trouble management facility used to update the trouble ticket held in generic format by the central exchange and wherein the translation module is operative to translate the trouble ticket from the generic format to the native format of the trouble management facility.

7. The trouble management facility of claim 2, being further operative to receive a referral of a trouble report from the second trouble management facility, wherein the trouble report and management module takes appropriate steps to respond to the referral and to generate relevant information in response to the steps taken, the relevant information including root cause and sub root cause information for the problem for which the referral was made, the translation module being operative to translate the generated information to the generic format used by the central exchange for transfer to the central exchange.

8. A central exchange mediating between at least a first trouble management facility and a second trouble management facility, comprising:
a first interface for exchanging information with the first trouble management facility;
a second interface for exchanging information with the second trouble management facility;
a trouble report management module for receiving and storing trouble tickets and referring problems reported by one of the trouble management facilities to another of the trouble management facilities as needed, the trouble management report module using a generic format for processing and storing the trouble tickets.

9. The central exchange of claim 8, further comprising a translation module for translating information between the native format of one or more of the first and second reporting facilities and the generic format used by the central exchange.

10. The central exchange of claim 8, further operative to receive information from a trouble management facility to which a problem is referred, to receive relevant information relating to the referred problem and to update the trouble ticket with the relevant information, the central exchange updating the trouble ticket with the relevant information by adding the information in the generic format of the central exchange.

11. The central exchange of claim 10, wherein the relevant information includes root cause and sub root cause information returned by the trouble management facility to which the problem was referred and the central exchange stores the root cause and sub root cause information in the trouble ticket in its generic format.

12. A method of trouble reporting and management, comprising the steps of:
receiving a report of trouble affecting a user of a communication system;
creating a trouble ticket for presenting and maintaining relevant information relating to the reported problem;
taking action as needed within a subsystem receiving the report;
when required, referring the trouble ticket for further operation by entities beyond the subsystem receiving the report, the referred trouble ticket having been translated from a native format used by the subsystem receiving the report to a generic format used by a central exchange mediating between the subsystem receiving the report and other subsystems.

13. The method of claim 12, wherein the trouble ticket is a stored record for management and routing by data processing facilities.

14. The method of claim 13, wherein creating the trouble ticket includes creating standardized trouble codes providing trouble information and wherein translating the information in the trouble ticket from the native format to the generic format includes translating native trouble codes used by the subsystem to generic trouble codes used by the central exchange.

15. The method of claim 13, further comprising a step of referring a problem report included in the trouble ticket to a receiving subsystem other than the subsystem originating the trouble ticket, the step of referring the problem report including translating the problem report from the generic format used by the central exchange to a native format used by the subsystem to which the problem is referred.

16. The method of claim 15, wherein the step of referring the problem report to a receiving subsystem other than the subsystem originating the trouble ticket includes the generation of relevant information in the native format of the receiving subsystem, and translating the relevant information to the generic format of the central exchange for use by the central exchange.

17. The method of claim 16, wherein the relevant information includes root cause and sub root cause information identifying the cause of the problem referred to the receiving subsystem.

18. The method of claim 17, wherein the root cause and sub root cause information includes root cause and sub root cause codes and wherein translating the relevant information to the generic format of the central exchange includes translating root cause and sub root cause codes used by the subsystem to root cause and sub root cause codes used by the central exchange.

19. The method of claim 18, further comprising a step of updating the trouble ticket with the relevant information generated by the receiving subsystem with the relevant information being stored in the trouble ticket in the generic format of the central exchange.

20. The method of claim 19, further including a step of translating the trouble ticket stored in the generic format to the native format used by the subsystem originating the trouble ticket.
